(19) United States
(12) Patent Application Publication
(10) Pub. No.: US 2024/0356624 A1
(43) Pub. Date: Oct. 24, 2024

(54) BEAM FAILURE RECOVERY INFORMATION TRANSMISSION APPARATUS, BEAM FAILURE RECOVERY INFORMATION RECEPTION APPARATUS, AND COMMUNICATION SYSTEM

(71) Applicant: FUJITSU LIMITED, Kawasaki-shi Kanagawa (JP)

(72) Inventors: Meiyi JIA, Beijing (CN); Guorong LI, Beijing (CN); Yang LU, Beijing (CN)

(73) Assignee: FUJITSU LIMITED, Kawasaki-shi Kanagawa (JP)

(21) Appl. No.: 18/762,741

(22) Filed: Jul. 3, 2024

Related U.S. Application Data
(63) Continuation of application No. PCT/CN2022/071132, filed on Jan. 10, 2022.

(51) Int. Cl. H04B 7/06; H04W 72/231

(52) U.S. Cl. CPC H04B 7/06964; H04W 72/231

(57) ABSTRACT

A beam failure recovery information transmitting apparatus, applicable to a terminal equipment, includes: processor circuitry configured to detect beam failures at two BFD-RS (beam failure detection reference signals) sets of a first cell; and a transmitter configured to transmit a first message in a random access procedure to a network device, the first message including a truncated beam failure recovery medium access control (MAC) control element (CE), the truncated beam failure recovery MAC CE including beam failure recovery information of a failed BFD-RS set.

### CROSS-REFERENCE TO RELATED APPLICATION

This application is a continuation application of International Application PCT/CN2022/071132 filed on Jan. 10, 2022, and designated the U.S., the entire contents of which are incorporated herein by reference.

### TECHNICAL FIELD

This disclosure relates to the field of communication technologies.

### BACKGROUND

In a New Radio (NR) system, transmission and reception of beams are supported, and management of multiple beams are also supported. A terminal equipment may execute a beam failure detection (BFD) procedure and a beam failure recovery (BFR) procedure.

During the beam failure recovery procedure, an MAC entity performs the following operations:
if it is determined in the beam failure recovery procedure that at least one BFR has been triggered and the BFR has not been canceled, evaluation of its candidate beams has been completed according to a requirement;
if an uplink resource (UL-SCH resource) is available for new transmission and a result of a logical channel prioritization (LCP) procedure is that the uplink resources can accommodate a BFR MAC CE plus its subheader, instructing a multiplexing and assembly procedure to generate a BFR MAC CE;
if the uplink resource is available for new transmission and the result of LCP is that the uplink resources can accommodate a truncated BFR MAC CE plus its subheader, instructing a multiplexing and assembly procedure to generate a truncated BFR MAC CE;
otherwise, triggering a scheduling request (SR) for each secondary cell that has triggered BFR and has not canceled BFR with candidate beams having been completed evaluation according to a requirement.

Therefore, beam failure recovery information may be carried by the BFR MAC CE or the truncated BFR MAC CE (hereinafter referred to as a truncated BFR MAC CE), and may be transmitted by the terminal equipment to the network device.

When a media access control (MAC) protocol data unit (PDU) is transmitted by the terminal equipment to the network device and the MAC PDU includes the BFR MAC control element (CE) or the truncated BFR MAC CE carrying the beam failure recovery information, the terminal equipment should cancel all BFR of the secondary cell triggered for beam failure recovery before the MAC PDU is assembled.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that in operations of multiple transmission/reception points (TRPs), if beam failures are detected in two TRPs, a terminal equipment needs to transmit beam failure recovery information of the two TRPs needing to be recovered during a random access procedure. Based on an existing mechanism, when resources of an Msg3/MSGA payload during the random access procedure are not large enough, the Msg3/MSGA payload is unable to carry an BFR MAC CE including the beam failure recovery information of the two TRPs needing to be recovered.

In order to solve at least one of the above problems, embodiments of this disclosure provide a beam failure recovery information transmission method and a beam failure recovery information reception method and apparatuses thereof.

According to one aspect of the embodiments of this disclosure, there is provided a beam failure recovery information transmission apparatus, applicable to a terminal equipment side, the apparatus including:
a detecting unit configured to detect beam failures at both transmission/reception points (TRPs) of a special cell; and
a first transmitting unit configured to transmit a first message in a random access procedure to a network device, the first message including a first beam failure recovery medium access control (MAC) control element (CE) having a fixed size, or the first message including a second beam failure recovery MAC CE, the first beam failure recovery MAC CE including beam failure recovery information of the two TRPs, and the second beam failure recovery MAC CE including beam failure recovery information of a first TRP in the two TRPs.

According to another aspect of the embodiments of this disclosure, there is provided a beam failure recovery information reception apparatus, applicable to a network device side, the apparatus including:
a second transmitting unit configured to transmit candidate beam configuration information to a terminal equipment; and
a fourth receiving unit configured to receive a first message in a random access procedure transmitted by the terminal equipment, the first message including a first beam failure recovery MAC CE having a fixed size or the first message including a second beam failure recovery MAC CE, the first beam failure recovery MAC CE including beam failure recovery information of two TRPs, and the second beam failure recovery MAC CE including beam failure recovery information of a first TRP in the two TRPs.

According to a further aspect of the embodiments of this disclosure, there is provided a communication system, including the terminal equipment as described in the one aspect and/or the network device as described in the other aspect.

An advantage of the embodiments of this disclosure exists in that when beam failures are detected at two TRPs, a BFR MAC CE having a fixed size including the beam failure recovery information of the two TRPs needing to be recovered is transmitted or a BFR MAC CE including the beam failure recovery information of one TRP needing to be recovered is transmitted during a random access procedure. Hence, Msg3/MSGA in the random access procedure is able to transmit beam failure recovery information of one or two TRPs at sufficient low overhead, enabling the network device to obtain the beam failure recovery information of the two TRPs, so that the network is able to perform beam recovery.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of this disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of an embodiment of this disclosure;

FIGS. 2 and 3 are schematic diagrams of MAC CE formats;

FIG. 4 is a schematic diagram of a multi-TRP scenario of an embodiment of this disclosure;

FIG. 5 is a schematic diagram of the beam failure recovery information transmission method of an embodiment of this disclosure;

FIGS. 6 and 7 are exemplary diagrams of a first MAC subheader of the embodiment of this disclosure;

FIGS. 8-13 are exemplary diagrams of a first beam failure recovery MAC CE of the embodiment of this disclosure;

FIG. 14 is a schematic diagram of the beam failure recovery information transmission method of an embodiment of this disclosure;

FIGS. 15 and 16 are exemplary diagrams of a second MAC subheader of the embodiment of this disclosure;

FIGS. 17A-17B are exemplary diagrams of a second beam failure recovery MAC CE of the embodiment of this disclosure;

FIGS. 18A-18B are exemplary diagrams of the second beam failure recovery MAC CE of the embodiment of this disclosure;

FIG. 19 is a schematic diagram of the beam failure recovery information reception method of an embodiment of this disclosure;

FIG. 20 is a schematic diagram of a beam failure recovery method of an embodiment of this disclosure;

FIG. 21 is a schematic diagram of the beam failure recovery information transmission apparatus of an embodiment of this disclosure;

FIG. 22 is a schematic diagram of a beam failure recovery apparatus of an embodiment of this disclosure;

FIG. 23 is a schematic diagram of the beam failure recovery information reception apparatus of an embodiment of this disclosure;

FIG. 24 is a schematic diagram of the network device of an embodiment of this disclosure; and

FIG. 25 is a schematic diagram of the terminal equipment of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term. Without causing confusion, terms “cell” and “base station” are interchangeable.

In the embodiments of this disclosure, the term “user equipment (UE)” or “terminal equipment (TE) or terminal equipment” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment, except otherwise specified.

In the embodiments of this disclosure, the cell-specific may be understood as cell-level or all beams, which are in a granularity of cells; and TRP-specific may be understood as TRP-level or partial beams, which are in a granularity of TRPs. The terms “a beam failure is detected” and “beam failure recovery is triggered” or “beam failure indication is triggered” are interchangeable, the terms “a beam” and “a reference signal” are interchangeable, terms “needing to be recovered” and “failed” are interchangeable, terms “a TRP” and “a part of or a BFD-RS set” are interchangeable, terms “a beam failure of a TRP” and “a part of beam failure or a beam failure of a BFD-RS set” are interchangeable, and terms “beam failure recovery of a TRP” and “a part of beam failure recovery or beam failure recovery of a BFD-RS set” are interchangeable.

Scenarios of the embodiments of this disclosure shall be described below by way of examples; however, this disclosure is not limited thereto.

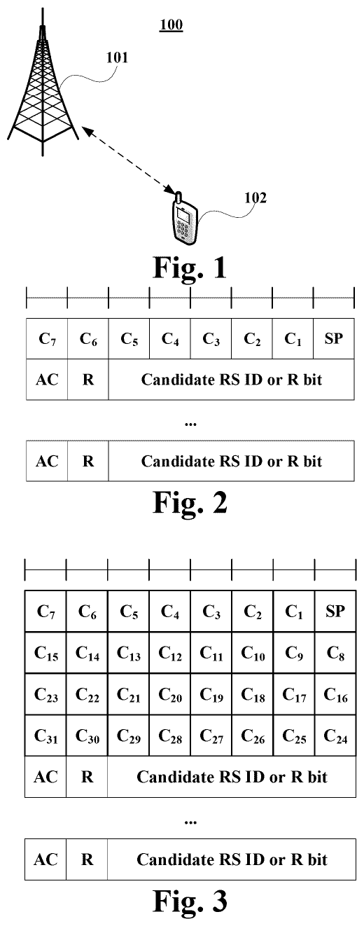

FIG. 1 is a schematic diagram of a communication system of this disclosure, in which a case where a terminal equipment and a network device are taken as examples is schematically shown. As shown in FIG. 1, a communication system 100 may include a network device 101 and a terminal equipment 102. For the sake of simplicity, an example having only one terminal equipment is schematically given in FIG. 1; however, the embodiment of this disclosure is not limited thereto, for example, there may be multiple terminal equipments.

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC), etc.

In a beam failure detection (BFD) procedure, an MAC entity of a media access control (MAC) layer of the terminal equipment detects a cell-specific beam failure by calculating the number of beam failure instance indications provided by a lower layer (such as a physical layer) to the MAC entity.

For example, the beam failure detection procedure uses a UE variable BFI_COUNTER. The variable is a counter of the beam failure instance indications, which is initially set to be 0, and each serving cell has a BFI_COUNTER. For each serving cell configured with beam failure detection, the MAC entity will perform the following operations (triggering of cell-level/cell-specific beam failure recovery):
if a beam failure instance indication is received from the lower layer: starting or restarting a beam failure detection timer beam FailureDetectionTimer, and adding 1 to a terminal equipment variable BFI_COUNTER; in a case where BFI_COUNTER is greater than or equal to a maximum count value beamFailureInstanceMaxCount of the beam failure instances: if the serving cell is a secondary cell (SCell), triggering beam failure recovery (BFR) of the serving cell; otherwise, initiating a random access procedure in a special cell (SpCell); if beamFailureDetectionTimer expires, or if a higher layer reconfigures beamFailureDetectionTimer or beamFailureInstanceMaxCount or any reference signal used for beam failure detection of the serving cell, setting BFI_COUNTER to be 0.

As described above, during the beam failure recovery procedure, the beam failure recovery information may be carried by a BFR MAC CE or a truncated BFR MAC CE and transmitted by the terminal equipment to the network device.

An MAC PDU is a byte aligned (i.e. a multiple of 8 bits) bit string. Usually, a bit string is represented by a table, in which a most significant bit is the leftmost bit in the first row in the table and the least significant bit is the rightmost bit in the last row in the table, and the bit string is read from left to right row by row. An MAC PDU includes one or more MAC sub-PDUs. Each MAC sub-PDU includes a MAC subheader, or an MAC subheader and an MAC service data unit (SDU), or an MAC subheader and an MAC CE, or an MAC subheader and padding.

An MAC subheader is a byte-aligned (i.e. a multiple of 8 bits) bit string. Each subheader corresponds to an MAC SDU, or an MAC CE, or padding, and each subheader is immediately placed before the MAC SDU or the MAC CE or the padding to which it corresponds.

An MAC SDU is a byte-aligned (i.e. a multiple of 8 bits) bit string, and its size is variable. An MAC SDU is included in an MAC PDU starting from a first bit.

An MAC CE is a byte-aligned (i.e. a multiple of 8 bits) bit string.

A BFR MAC CE and a truncated BFR MAC CE are identified by the MAC header carrying a logical channel identifier/extended logical channel identifier (LCID/eLCID). For example, the BFR MAC CE carries a logical channel identifier 50, and the truncated BFR MAC CE carries a logical channel identifier 51, or the BFR MAC CE carries a logical channel identifier 33 or 34 and an extended logical channel identifier 250, and the truncated BFR MAC CE carries a logical channel identifier 33 or 34 and an extended logical channel identifier 251.

Sizes of the BFR MAC CE and truncated BFR MAC CE are variable. They include a bitmap and beam failure recovery information arranged in an ascending order of ServCellIndex, that is, they include bytes of candidate beam availability indication (AC) of a secondary cell indicated by the bitmap.

FIG. 2 is a schematic diagram of a BFR MAC CE or truncated BFR MAC CE in a first format (referred to as format 1), and FIG. 3 is a schematic diagram of a BFR MAC CE or truncated BFR MAC CE in a second format (referred to as format 2).

Specifically, for the BFR MAC CE, if the MAC entity has detected a beam failure and a highest serving cell index ServCellIndex of a secondary cell with candidate beams having been evaluated according to a requirement is less than 8, format 1 (one-byte bitmap) in FIG. 2 is used; otherwise, format 2 (four-byte bitmap) in FIG. 3 is used.

For the truncated BFR MAC CE, if the MAC entity has detected a beam failure and a highest serving cell index ServCellIndex of a secondary cell with candidate beams having been evaluated according to a requirement is less than 8, or, if a beam failure is detected in a special cell and the special cell is included in a truncated BFR MAC CE and an LCP result is that UL-SCH resources cannot accommodate the truncated BFR MAC CE in format 2 in FIG. 3 plus its subhead, format 1 in FIG. 2 is used; otherwise, format 2 in FIG. 3 is used.

For example, fields of format 1 and format 2 are defined as follows.

The AC field indicates existence of a candidate RS ID field in this byte. If the AC field is set to be 1, the candidate RS ID field presents. If this AC field is set to be 0, R bits presents and a candidate RS ID field is set to be an index of SSB or a CSI-RS. A length of the field is 6 bits, and an R field identifier reserves a bit, which is set to be 0; and an SP field indicates beam failure detection of a special cell of the MAC entity. The SP field is set to be 1 only when the BFR MAC CE or truncated BFR MAC CE will be included in an MAC PDU and taken as a part of the random access procedure, indicating that a beam failure of the special cell; otherwise, it is set to be 0.

For the BFR MAC CE, a Ci field indicates beam failure detection of a secondary cell of ServCellIndex i, whether evaluation of a candidate beam according to a requirement is completed and whether there may possibly exist a byte consisting of the AC field, and the AC field indicates whether there exists a candidate RS ID field in this byte and the candidate RS ID field is set to be an index of SSB or CSI-RS.

Setting the Ci field to be 1 indicates that a beam failure is detected in the secondary cell of ServCellIndex i, the evaluation of candidate beams according to a requirement has been completed and there exists a byte including the AC field. Setting the Ci field to be 0 indicates that a beam failure is not detected in the secondary cell of ServCellIndex i, or a beam failure is detected but evaluation of candidate beams according to a requirement has not been completed and there exists no byte including the AC field. If a byte including the AC field presents, it presents in an ascending order of ServCellIndex.

For the truncated BFR MAC CE, the Ci field indicates beam failure detection of the secondary cell of ServCellIndex i, whether the evaluation of candidate beams according to a requirement has been completed and whether there may possibly exist a byte consisting of the AC field, and the AC field indicates whether there presents a candidate RS ID field in this byte and the candidate RS ID field is set to be an index of SSB or CSI-RS.

Setting the Ci field to be 1 indicates that a beam failure is detected in the secondary cell of ServCellIndex i, the evaluation of candidate beams according to a requirement has been completed and there may possibly exist a byte including the AC field. Setting the Ci field to be 0 indicates that a beam failure is not detected in the secondary cell of ServCellIndex i, or a beam failure is detected but evaluation of candidate beams according to a requirement has not been completed and there exists no byte including the AC field. If a byte including the AC field presents, it presents in an ascending order of ServCellIndex. The number of bytes including the AC field may be 0, and does not exceed a size of an available grant.

The (truncated) BFR MAC CE is schematically described above, and relevant scenarios of the embodiments of this disclosure shall be described below. In the embodiments of this disclosure, a beam may be replaced with a reference signal (RS), such as being denoted by an SSB or a CSI-RS.

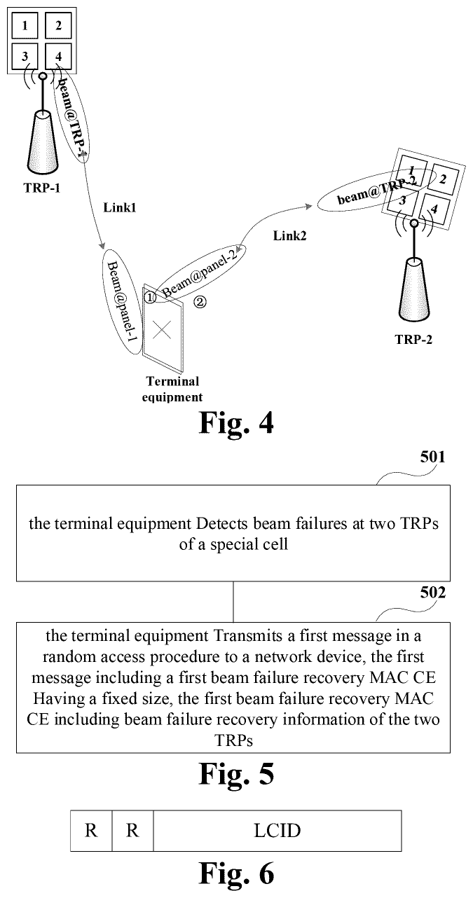

FIG. 4 is a schematic diagram of a multi-TRP scenario in an embodiment of this disclosure. A TRP may be a part of a network device (such as a gNB) that receives signals from a terminal equipment, and may also be a part of a network device (such as a gNB) that transmits signals to the terminal equipment. In addition, the TRP may denote a set of downlink control information (DCI) or a set of reference signals, etc.

As shown in FIG. 4, in the scenario of multi-TRP operations, the terminal equipment may have pannel-1 and pannel-2; and a serving cell may schedule the terminal equipment from two TRPs, so as to provide better physical downlink shared channel (PDSCH) coverage, reliability, and/or data rates.

For the multi-TRP operations, there are two different operating modes, namely single-DCI and multi-DCI. For these two modes, control of uplink and downlink operations is performed by a physical layer and an MAC layer. In the single-DCI mode, the terminal equipment is scheduled by two TRPs via identical DCI, and in the multi-DCI mode, the terminal equipment is scheduled by separate DCI of each TRP. Or, the network device provides services to the terminal via TRP-1 and TRP-2. These two TRPs may belong to the same cell, or may belong to different cells.

In triggering of TRP-specific beam failure recovery, for each serving cell configured with beam failure detection, the MAC entity:

If this serving cell is configured with multiple BFD-RS sets, for each BFD-RS set in this serving cell, the MAC entity:
if a beam failure instance indication of a BFD-RS set is received from the lower layer, starts or restarts a beam failure detection timer beamFailureDetectionTimer, and adds 1 to BFI_COUNTER;
if BFI_COUNTER is greater than or equal to beamFailureInstanceMaxCount, triggers BFR of the BFD-RS set of the serving cell;
if BFR is triggered at two BFD-RS sets of the serving cell and the BFR is suspended, if the serving cell is a special cell (SpCell), initiate a random access procedure on the special cell; and if the serving cell is a special cell and a random access procedure initiated for beam failure recovery of two BFD-RS sets of the special cell is successfully completed, sets BFI_COUNTER of each BFD-RS set of the special cell to be 0, and deems that the beam failure recovery procedure is successfully completed.

If beamFailureDetectionTimer of this BFD-RS set expires, or if a higher layer reconfigures beamFailureDetectionTimer or beamFailureInstanceMaxCount or any reference signal used for beam failure detection of the BFD-RS set of the serving cell, BFI_COUNTER is set to be 0.

If a PDCCH addressed to a C-RNTI is received, it indicates a new uplink grant of an HARQ process for transmitting an enhanced BFR MAC CE or truncated enhanced BFR MAC CE including beam failure recovery information of the BFD-RS set of the serving cell, or, if the secondary cell is deactivated, BFI_COUNTER is set to be 0.

When an MAC PDU is transmitted and the PDU includes an enhanced BFR MAC CE or a truncated enhanced BFR MAC CE including beam failure recovery information of a BFD-RS of the secondary cell, all BFRs triggered for the BFD-RS set of the special cell are canceled.

The beam failure recovery MAC CEs of the BFD-RS set include enhanced BFR MAC CEs or truncated enhanced BFR MAC CEs. The enhanced BFR MAC CEs support formats of single-byte bitmaps (7 Ci bits and 1 SP bit) and four-byte bitmaps (31 Ci bits and 1 SP bit).

The enhanced BFR MAC CEs include the following information: for determining a serving cell of a failed TRP, including a Ci/SP field; for indicating whether a candidate beam of a failed TRP of a serving cell is available, including an AC field; for indicating a candidate beam (if available) of a failed TRP by including a candidate RS ID field.

It was found by the inventors that when beam failures are detected at two TRPs in a special cell, the terminal equipment needs to initiate a random access procedure and transmit beam failure recovery information including the two TRPs needing to be recovered in MSG3/MSGA. The BFR MAC CE carrying the beam failure recovery information including the two TRPs needing to be recovered at least needs 5 bytes, such as including a 2-byte subheader+a 1-byte bitmap+1-byte beam failure recovery information of failed TRP1+1-byte beam failure recovery information of failed TRP2. For a case of a minimum size of 7 bytes available for MSG3, at least a 2-byte C-RNTI MAC CE and subheader (1 byte) need to be included, and the remaining 4 bytes are insufficient to carry the BFR MAC CE needing at least 5 bytes described above.

Addressed to the above problems, following description shall be given with reference to the embodiments of this disclosure.

### Embodiment of a First Aspect

The embodiment of this disclosure provides a beam failure recovery information transmission method, which shall be described from a terminal equipment.

FIG. 5 is a schematic diagram of the beam failure recovery information transmission method of the embodiment of this disclosure. As shown in FIG. 5, the method includes:
501: the terminal equipment detects beam failures at two TRPs of a special cell; and
502: the terminal equipment transmits a first message in a random access procedure to a network device, the first message including a first beam failure recovery MAC CE having a fixed size, the first beam failure recovery MAC CE including beam failure recovery information of the two TRPs.

It should be noted that FIG. 5 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, a special cell may be configured with two BFD-RS sets (corresponding to the two TRPs). In the following description, for the sake of convenience, the two TRPs are referred to as a first TRP and a second TRP, and the two BFD-RS sets are referred to as a first BFD-RS set associated with the first TRP and a second BFD-RS set associated with the second TRP.

In some embodiments, in 501, the terminal equipment detects beam failures at two TRPs of a special cell refers to that the terminal equipment detects a beam failure at the first TRP (or in other words, a beam failure occurs on the first BFD-RS set), and also detects a beam failure at the second TRP (or in other words, a beam failure occurs on the second BFD-RS set). An order of detecting a beam failure at the first TRP and detecting a beam failure at the second TRP is not limited in this disclosure.

In some embodiments, that the terminal equipment detects a beam failure at the first TRP refers to a case where a beam failure instance indication of the first BFD-RS set is received from a lower layer, a beam failure detection timer beam FailureDetectionTimer is started or restarted, and 1 is added to a terminal equipment variable BFI_COUNTER, and BFI_COUNTER is greater than or equal to a beam failure instance maximum count value beamFailureInstanceMaxCount. That the terminal equipment detects a beam failure at the second TRP refers to a case where a beam failure instance indication of the second BFD-RS set is received from a lower layer, a beam failure detection timer beam FailureDetectionTimer is started or restarted, and 1 is added to a terminal equipment variable BFI_COUNTER, and BFI_COUNTER is greater than or equal to a beam failure instance maximum count value beamFailureInstanceMaxCount.

In some embodiments, as the serving cell is a special cell, when beam failures are detected at the two TRPs, the terminal equipment needs to initiate a random access procedure. The random access procedure may be related contention-based random access, which includes two times of exchange between the network device and the terminal equipment, wherein in a first time of exchange, the terminal equipment initiates a random access request (MSG1) and receives a random access response (MSG2) fed back by the network device, and in a second time of exchange, the terminal equipment transmits information including a user identity to the network device (MSG3) and receives MSG4 fed back by the network device; or, the random access procedure may also be two-step random access, wherein original MSG1 and MSG3 are merged into a new MSGA, and MSG2 and MSG4 are merged into MSGB. Reference may be made to existing techniques for details, which shall not be repeated herein any further.

In some embodiments, in 502, the terminal equipment transmits the first message in the random access procedure to the network device, the first message including a first beam failure recovery MAC CE having a fixed size, rather than a BFR MAC CE of a variable size. Therefore, the first message in the random access procedure may carry beam failure recovery information of the two TRPs at sufficient low overhead, so that the network performs beam recovery.

In some embodiments, the first message may include MSG3 or MSGA, the MSG3 or MSGA carrying the first beam failure recovery MAC CE. A format of the first beam failure recovery MAC CE shall be described below.

An MAC subheader of the first beam failure recovery MAC CE shall be described first.

In some embodiments, the first MAC subheader to which the first beam failure recovery MAC CE corresponds at least includes a first LCID. The first LCID is used to indicate the first beam failure recovery MAC CE having a fixed size, and is 6 bits. Alternatively, the first MAC subheader may also include 2 reserved bits, and such a first MAC subheader may be 1 byte. FIG. 6 is an exemplary diagram of the first MAC subheader. As shown in FIG. 6,
for example, if a value of the first LCID is a reserved value of LCID for UL-SCH, such as one of 35,36,43,44, that is, when the network device receives an MAC CE and a value of an LCID of an MAC subheader therein is a reserved value of the LCID, such as one of 35,36,43,44, it may indicate that the MAC CE is the first beam failure recovery MAC CE having a fixed size.

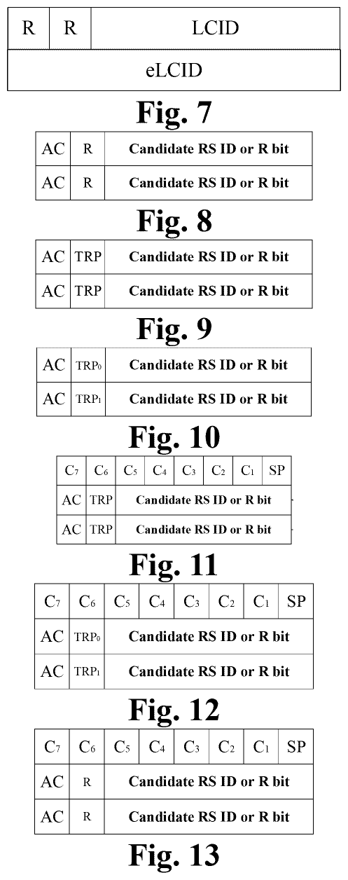

In some embodiments, the first MAC subheader to which the first beam failure recovery MAC CE corresponds at least includes a first LCID and a first eLCID, the first LCID being used to indicate an extended LCID field, the first eLCID being used to indicate the first beam failure recovery MAC CE having a fixed size, the first LCID being 6 bits, and the first eLCID being 8 bits; and optionally, the first MAC subheader may also include 2 reserved bits, and such a first MAC subheader may be 2 bytes. FIG. 7 is an exemplary diagram of the first MAC subheader. As shown in FIG. 7,
for example, if a value of the first LCID is 33 or 34 and is used to indicate an extended LCID, and a value of the first eLCID is a reserved value of an eLCID of a UL-SCH, such as one of 0-249, that is, when the network device receives an MAC CE, a value of an LCID of an MAC subheader therein is 33 or 34 and a value of the eLCID is a reserved value, such as one of 0-249, it may indicate that the MAC CE is the first beam failure recovery MAC CE having a fixed size.

In some embodiments, the size of the first beam failed recovery MAC CE is fixed rather than variable, therefore, the first MAC subheader may not include bit information indicating a length (L), or in other words, the first MAC subheader does not need bit information indicating a length.

A format of the first beam failure recovery MAC CE shall be described below.

In some embodiments, the first beam failure recovery MAC CE at least includes an AC field and a candidate reference signal ID field or a reserved bit field, the AC field being used to indicate whether a candidate beam of a failed TRP of the special cell is available and being 1 bit, and the candidate reference signal ID field being used to indicate a candidate beam of the failed TRP and being an index of an SSB or a CSI-RS, and the candidate reference signal ID field or reserved bit field being 6 bits. For example, when a value of the AC field is 1, it indicates that the candidate beam of the failed TRP is available, and the first beam failure recovery MAC CE includes the candidate reference signal ID field; and when a value of the AC field is 0, it indicates that the candidate beam of the failed TRP is unavailable, and the first beam failure recovery MAC CE includes the reserved bit field.

In some embodiments, FIG. 8 is a schematic diagram of a format of the first beam failure recovery MAC CE. As shown in FIG. 8, the first beam failure recovery MAC CE only includes an AC field and a candidate reference signal ID field or a reserved bit field, and the remaining bits are reserved bits R. The terminal equipment and the network device will deem that a first occurred AC byte corresponds to the beam failure recovery information of the first TRP of the special cell, and a second occurred AC byte corresponds to the beam failure recovery information of the second TRP of the special cell, and vice versa, and this disclosure is not limited thereto. A subheader of the BFR MAC CE illustrated in FIG. 8 may use the format of the subheader shown in FIG. 6 or FIG. 7.

In some embodiments, the first beam failure recovery MAC CE may further include a TRP information field. The TRP information field has a size of 1 bit, and is used to indicate the failed TRP in the two TRPs or is used to indicate a BFD-RS set of a special cell where a beam failure is detected. That is, it at least includes an AC field, a candidate reference signal ID field or a reserved bit field and a TRP information field. Meanings of the AC field and candidate reference signal ID field or reserved bit field are as described above, which shall not be repeated herein any further.

For example, the TRP information field is used to indicate the failed TRP in the two TRPs, and a value of the TRP information field is an index of the TRP where a beam failure is detected or an index a beam failure detection reference signal (BFD-RS) set or an index of a control resource pool (coreset pool) with which an index of the TRP where a beam failure is detected is associated. Setting the TRP field to be 0 indicates that a beam failure is detected at the first TRP of the special cell (or, in other words, a beam failure is detected at a BFD-RS set with a special cell having an index 0 or a beam failure is detected in a coreset pool with an index 0), and setting the TRP field to be 1 indicates that a beam failure is detected at the second TRP of the special cell (or, in other words, a beam failure is detected at a BFD-RS set with a special cell having an index 1 or a beam failure is detected in a coreset pool with an index 1). FIG. 9 is an exemplary diagram of the format of the first beam failure recovery MAC CE. As shown in FIG. 9, the first beam failure recovery MAC CE only includes an AC field, a candidate reference signal ID field or a reserved bit field and a TRP information field.

For example, the TRP information field is used to indicate whether a beam failure is detected at a TRP with an index i (or whether a beam failure is detected at a BFD-RS set with a special cell having an index i or whether a beam failure is detected in a coreset pool with an index i), and is hereinafter referred to as a TRPᵢ information field, the TRPᵢ indicating whether a beam failure is detected at BFD-RS set i of a special cell. When a value of the TRP information field is a first value, it indicates that no beam failure is detected at the TRPᵢ (or the BFD-RS set i or a coreset poolᵢ), and when a value of the TRP information field is a second value, it indicates that a beam failure is detected at the TRPᵢ (or the BFD-RS set i or the coreset poolᵢ). For example, setting the TRPᵢ field to be 0 indicates that no beam failure is detected at the first TRP (TRP₀) or BFD-RS set i of the special cell (or the coreset poolᵢ), and setting the TRPᵢ field to be 1 indicates that a beam failure is detected at the second TRP (TRP₁) or BFD-RS set i of the special cell (or the coreset poolᵢ), and vice versa. FIG. 10 is an exemplary diagram of the format of the first beam failure recovery MAC CE. As shown in FIG. 10, the first beam failure recovery MAC CE only includes an AC field, a candidate reference signal ID field or a reserved bit field and a TRPᵢ information field. The subheaders of the BFR MAC CEs illustrated in FIGS. 9 and 10 may use the format of the subheader shown in FIG. 6 or 7.

In some embodiments, the first beam failure recovery MAC CE may further include a Ci/SP field, the Ci/SP field being used to determine a serving cell of a failed TRP, and a size thereof being 1 byte. The SP field indicates beam failure detection of a TRP of a special cell of the MAC entity. Setting the SP field to be 1 indicates that a beam of the TRP of the special cell fails; otherwise, the SP field is set to be 0. The Ci field indicates beam failure detection of (a TRP of) the secondary cell of ServCellIndex i. Setting the Ci field to be 1 indicates that a beam failure is detected in (a TRP of) the secondary cell of ServCellIndex i, and setting the Ci field to be 0 indicates that no beam failure is detected in (a TRP of) the secondary cell of ServCellIndex i.

For example, FIG. 11 is a schematic diagram of the format of the first beam failure recovery MAC CE. As shown in FIG. 11, the first beam failure recovery MAC CE may only include an AC field, a candidate reference signal ID field or a reserved bit field, a Ci/SP field and a TRP information field. Meanings of these fields are as described above, which shall not be repeated herein any further.

For example, FIG. 12 is a schematic diagram of the format of the first beam failure recovery MAC CE. As shown in FIG. 12, the first beam failure recovery MAC CE may only include an AC field, a candidate reference signal ID field or a reserved bit field, a Ci/SP field and a TRPᵢ information field. Meanings of these fields are as described above, which shall not be repeated herein any further.

For example, the TRP information field or TRPᵢ information field in FIG. 11 or 12 may be replaced with a reserved bit R. FIG. 13 is a schematic diagram of the format of the first beam failure recovery MAC CE. As shown in FIG. 13, the first beam failure recovery MAC CE may only include an AC field, a candidate reference signal ID field or a reserved bit field and a Ci/SP field. The terminal equipment and the network device will deem that a first occurred AC byte corresponds to the beam failure recovery information of the first TRP of the special cell and a second occurred AC byte corresponds to the beam failure recovery information of the second TRP of the special cell, and vice versa, and this disclosure is not limited thereto. The subheaders of the BFR MAC CEs illustrated in FIGS. 11-13 may use the format of the subheader shown in FIG. 6.

In some embodiments, the method may further include at least one of the following (optional, not shown):
the terminal equipment receives a random access response (RAR), an uplink grant indicated by the RAR or an uplink resource configured by the RAR being insufficient to carry an enhanced (truncated) beam failure recovery MAC CE including the beam failure recovery information of the two failed TRPs;
the terminal equipment receives first indication information transmitted by the network device;
the terminal equipment detects that a highest serving cell index ServCellIndex of a secondary cell where the TRP with beam failure is located/with which the TRP with beam failure is associated is less than 8; or
the terminal equipment detects that the special cell where the TRP with beam failure is located is to be indicated as being in a truncated BFR MAC CE and UL-SCH resources cannot accommodate a truncated BFR MAC CE with a 4 octets bitmap plus its subheader as a result of logical channel prioritization (LCP).

In some embodiments, when at least one of the above occurs, the first message includes a first beam failure recovery MAC CE.

For example, the first indication information may be denoted by 1 bit to indicate that there are few resources to accommodate the first message, or to indicate that the first message carries minimum data, or to indicate that the first message includes a first beam failure recovery MAC CE. The first indication information is included in the RAR, or in a UL grant of the RAR, or in DCI scheduling the RAR, and the embodiment of this disclosure is not limited thereto.

It can be seen from the above embodiment that the terminal equipment transmits the first message in the random access procedure to the network device, the first message including a first beam failure recovery MAC CE having a fixed size, rather than a BFR MAC CE of a variable size. Therefore, the first message in the random access procedure may carry beam failure recovery information of the two TRPs at sufficient low overhead, so that the network performs beam recovery.

### Embodiment of a Second Aspect

The embodiment of this disclosure provides a beam failure recovery information transmission method, which shall be described from a terminal equipment.

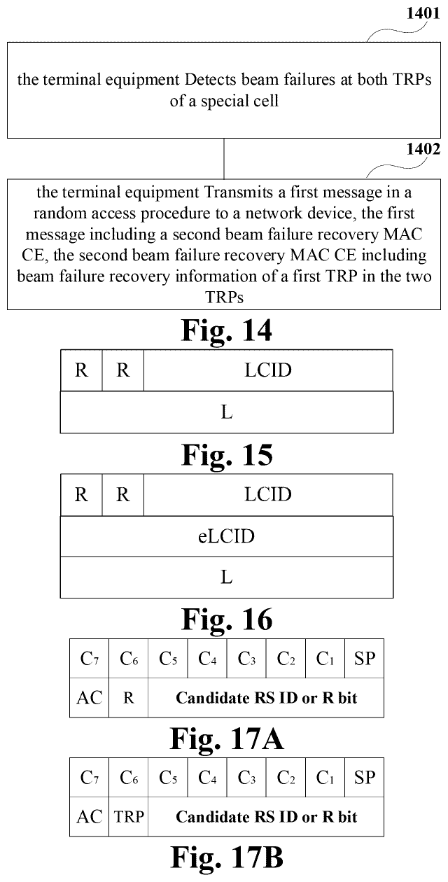

FIG. 14 is a schematic diagram of the beam failure recovery information transmission method of the embodiment of this disclosure. As shown in FIG. 14, the method includes:
1401: the terminal equipment detects beam failures at both TRPs of a special cell; and
1402: the terminal equipment transmits a first message in a random access procedure to a network device, the first message including a second beam failure recovery MAC CE, the second beam failure recovery MAC CE including beam failure recovery information of a first TRP in the two TRPs.

In some embodiments, reference may be made to 501-502 for a part of implementations of 1401-1402, with repeated parts being not go to be described herein any further. A difference from the embodiment of the first aspect is that the first message includes the second beam failure recovery of MAC CE, rather than the first beam failure recovery of MAC CE, which shall be described below in detail.

In some embodiments, in 1401, the terminal equipment detects beam failures at both the first TRP and the second TRP of the special cell. In 1402, the terminal equipment initiates a random access procedure on a random access resource of the second TRP in the TRPs, the first message including the second beam failure recovery MAC CE, the second beam failure recovery MAC CE including the beam failure recovery information of the first TRP. Hence, the first message of the random access procedure may carry beam failure recovery information of one TRP and implicitly indicate beam failure recovery information of the other TRP, so that the network performs beam recovery. This embodiment may reuse format of existing BFR MAC CEs at a relatively low cost. Implicitly indicating the beam failure recovery information of the other TRP shall be described first.

In some embodiments, the method may further include (not shown):
the terminal equipment receives, candidate beam configuration information transmitted by the network device, the configuration information including TRP related information, the TRP related information being the index of the failed TRP or the index of the BFD-RS set where beam failure is detected or index of the coreset pool associated with the BFD-RS set where beam failure is detected, or an index of a TRP where a candidate beam or random access resource is located, or an index of a BFD-RS set corresponding to the TRP or an index of a coreset pool associated with BFD-RS set.

For example, the candidate beam configuration information may be denoted by a field candidate BeamRSList or candidate BeamRSListExt-v1610 or a new field candidateBeamRSListExt-v17. The list invokes multiple PRACH-Resource DedicatedBFR information elements including reference signals and corresponding dedicated random access resources and/or dedicated random access preambles, and adds TRP related information (such as an index of the failed TRP or an index of the BFD-RS set where a beam failure is detected or an index of a coreset pool associated with the BFD-RS set where a beam failure is detected, or an index of a TRP where a candidate beam or random access resource is located or an index of a BFD-RS set to which the TRP corresponds or an index of a coreset pool associated with the BFD-RS set) to these information elements. The PRACH-Resource DedicatedBFR information element may be selected from an SSB and CSI-RS, hence, the candidate beam configuration information includes the SSB/CSI-RS, TRP related information and dedicated random access resources and/or dedicated random access preambles. Therefore, the random access resources may be configured in association with the TRPs, and the second TRP may be implicitly indicated by random access resources associated with the second TRP used by the terminal equipment.

In some embodiments, the terminal equipment transmits a random access preamble at an RO to which a first downlink reference signal corresponds, the first downlink reference signal corresponding to the second TRP. That is, in the random access procedure, the MAC entity selects the first downlink reference signal associated with the second TRP, and transmits the random access preamble at the RO to which the first downlink reference signal corresponds. Hence, the beam failure recovery information of the second TRP may be implicitly indicated.

A format of the second beam failure recovery MAC CE shall be described below.

An MAC subheader of the second beam failure recovery MAC CE shall be described first.

In some embodiments, the second MAC subheader to which the second beam failure recovery MAC CE corresponds at least includes a second LCID. The second LCID is used to indicate a single bitmap BFR MAC CE, or a single bitmap truncated BFR MAC CE, or an enhanced BFR MAC CE, and the second LCID is 6 bits. Optionally, the second MAC subheader may also include 2 reserved bits. FIG. 15 is an exemplary diagram of the second MAC subheader. As shown in FIG. 15,
for example, a value of the second LCID is 50, indicating reusing a format of an MAC CE of existing (e.g. Rel-16) single bitmap BFR, or, a value of the second LCID is 51, indicating reusing a format of an MAC CE of existing (e.g. Rel-16) single bitmap truncated BFR, or, a value of the second LCID is any of the reserved values 35-44, indicating using a format of an enhanced BFR MAC CE, or, in other words, a value of the second LCID is equal to a value of an LCID indicating the format of the enhanced BFR MAC CE.

In some embodiments, the second MAC subheader to which the second beam failure recovery MAC CE corresponds at least includes a second LCID and a second eLCID, the second LCID being used to indicate an extended LCID field, the second eLCID being used to indicate an MAC CE of beam failure recovery, the second LCID being 6 bits, and the second eLCID being 8 bits; and optionally, the second MAC subheader may also include 2 reserved bits. FIG. 16 is an exemplary diagram of the second MAC subheader. As shown in FIG. 16,
for example, if a value of second LCID is 33 or 34 and is used to indicate an extended LCID, and a value of the second eLCID is a 250, indicating an MAC CE of four bitmaps length BFR, or a value of the second eLCID is 251, indicating an MAC CE of four bitmaps length truncated BFR.

In some embodiments, as the second beam failure recovery MAC CE is not fixed in size, as shown in FIGS. 15 and 16, the second MAC subheader may also include bit information indicating a length, the bit information indicating a length of a corresponding MAC SDU or an MAC CE of a variable size.

The format of the second beam failure recovery MAC CE shall be described below.

In some embodiments, the second beam failure recovery MAC CE may reuse a format of an existing (e.g. Rel-16) single bitmap BFR MAC CE or a format of a single bitmap of truncated BFR MAC CE, or use a format of an enhanced BFR MAC CE.

For example, the second beam failure recovery MAC CE includes an AC field, a candidate reference signal ID field or a reserved bit field and a Ci/SP field. The AC field is used to indicate whether a candidate beam of a failed TRP of the special cell is available or is used to indicate whether a candidate reference signal ID field presents. The AC field is 1 bit, and the candidate reference signal ID field is used to indicate a candidate beam of the failed TRP. The candidate reference signal ID field is an index of an SSB or CSI-RS, and the candidate reference signal ID field or the reserved bit field is 6 bits. For example, when a value of the AC field is 1, it indicates that the candidate beam of the failed TRP is available, and the second beam failure recovery MAC CE includes the candidate reference signal ID field; and when a value of the AC field is 0, it indicates that the candidate beam of the failed TRP is unavailable, and the second beam failure recovery MAC CE includes the reserved bit field. The Ci/SP field is used to determine a serving cell of a failed TRP, and a size thereof is 1 byte. The SP field indicates beam failure detection of the TRP of the special cell of the MAC entity. Setting the SP field to be 1 indicates TRP beam failure of the special cell; otherwise, setting it to be 0. The Ci field indicates beam failure detection of (a TRP of) a secondary cell of ServCellIndex i. Setting the Ci field to be 1 indicates that a beam failure is detected in (the TRP of) of the secondary cell of ServCellIndex i, and setting the Ci field to be 0 indicates that no beam failure is detected in (the TRP of) of the secondary cell of ServCellIndex i.

In some embodiments, FIG. 17A is a schematic diagram of the format of the second beam failure recovery MAC CE. As shown in FIG. 17A, the second beam failure recovery MAC CE only includes an AC field, a candidate reference signal ID field or a reserved bit field and a Ci/SP field, and the remaining bits are reserved bits R. The terminal equipment and the network device will deem that the beam failure recovery information of the first TRP is included in the second beam failure recovery MAC CE, and the beam failure recovery information of the second TRP is implicitly indicated by a random access resource used in the random access procedure. That is, the network device may obtain the beam recovery failure information of the second TRP via the random access resource. As the special cell is configured with two TRPs, it will be directly determined that the first TRP to which the second beam failure recovery MAC CE corresponds is another TRP than the second TRP, and it is not needed to explicitly indicate the first TRP by setting the TRP information field in FIG. 17B. The subheader of the BFR MAC CE illustrated in FIG. 17A may use the format of the subheader shown in FIG. 15.

In some embodiments, the second beam failure recovery MAC CE may further include a TRP information field, with a size of 1 bit. The TRP information field is used to indicate the failed first TRP or a BFD-RS set or coreset pool of a special cell where a beam failure is detected, the BFD-RS set or coreset pool corresponding to the first TRP. That is, at least an AC field, a candidate reference signal ID field or a reserved bit field, a Ci/SP field and a TRP information field are included. Meaning of the AC field and the candidate reference signal ID field or the reserved bit field and the Ci/SP field are as described above, which shall not be repeated herein any further.

For example, the TRP information field is used to indicate the failed first TRP or a BFD-RS set or coreset pool of a special cell where a beam failure is detected. The BFD-RS set or coreset pool corresponds to the first TRP, and shall be hereinafter referred to as a TRP information field. The TRP indicates that a beam failure is detected at the first TRP, or that a beam failure is detected at the BFD-RS set (or coreset pool) i of the special cell. Setting the TRP field to be 0 indicates that a beam failure is detected at TRP₀ (taken as the first TRP) or the BFD-RS set (or coreset pool) 0 of the special cell, and setting the TRP field to be 1 indicates that a beam failure is detected at TRP₁ (taken as the first TRP) or the BFD-RS set (or coreset pool) 1 of the special cell. FIG. 17B is an exemplary diagram of the format of the second BFR MAC CE. As shown in FIG. 17B, the second BFR MAC CE only includes an AC field, a candidate reference signal ID field or a reserved bit field, a Ci/SP field and a TRP information field. A subheader of the BFR MAC CE illustrated in FIG. 17B may use the format of the subheader shown in FIG. 15.

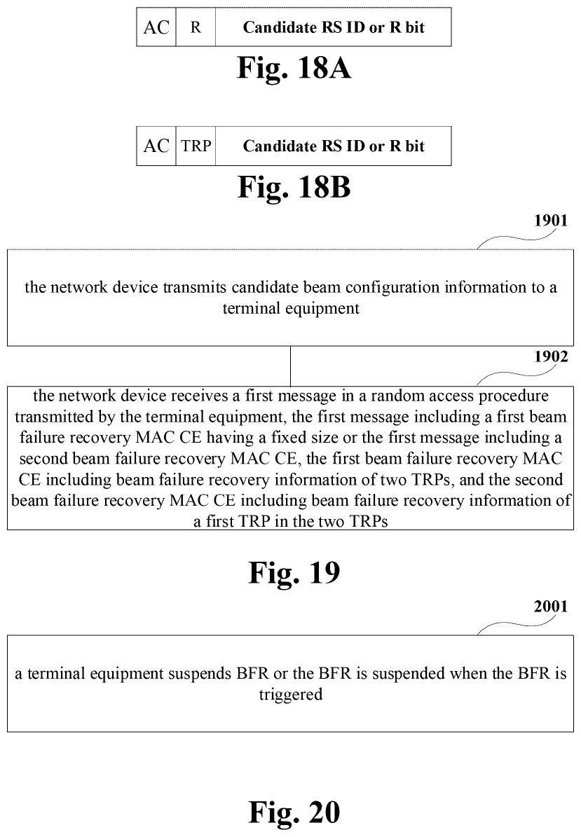

In some embodiments, a difference between FIGS. 17A and 17B is that the second beam failure recovery MAC CE may not include the Ci/SP field. FIG. 18A is a schematic diagram of the second beam failure recovery MAC CE format. As shown in FIG. 18A, the second beam failure recovery MAC CE may only include an AC field and a candidate reference signal ID field or a reserved bit field. Meanings of the AC field and the candidate reference signal ID field or the reserved bit field are identical to those in FIG. 17A, which shall not be repeated herein any further. FIG. 18B is another schematic diagram of the format of the second beam failure recovery MAC CE. As shown in FIG. 18B, the second beam failure recovery MAC CE may only include an AC field, a candidate reference signal ID field or a reserved bit field and a TRP information field. Meanings of the AC field, the candidate reference signal ID field or reserved bit field and the TRP information field are identical to those in FIG. 17B, which shall not be repeated herein any further. Subheaders of the BFR MAC CEs illustrated in FIGS. 18A and 18B may use the format of the subheader shown in FIG. 15 or 16, and the embodiment of this disclosure is not limited thereto.

In some embodiments, the method may further include at least one of the following (optional, not shown):
the terminal equipment receives an RAR, an uplink grant indicated by the RAR or an uplink resource configured by the RAR being insufficient to carry an enhanced beam failure recovery MAC CE including the beam failure recovery information of the two failed TRPs;
the terminal equipment receives, first indication information transmitted by the network device;
the terminal equipment detects that a highest serving cell index ServCellIndex of a secondary cell where the TRP with beam failure is located/with which the TRP with beam failure is associated is less than 8; or
the terminal equipment detects that the special cell where the TRP with beam failure is located is to be indicated as being in a truncated BFR MAC CE and UL-SCH resources cannot accommodate a truncated BFR MAC CE with a 4 octets bitmap plus its subheader as a result of logical channel prioritization (LCP).

In some embodiments, when at least one of the above occurs, the first message includes a second beam failure recovery MAC CE.

For example, the first indication information may be denoted by 1 bit to indicate that there are few resources to accommodate the first message, or to indicate that the first message carries minimum data, or to indicate that the first message includes a second beam failure recovery MAC CE. The first indication information is included in the RAR, or in a UL grant of the RAR, or in DCI scheduling the RAR, and the embodiment of this disclosure is not limited thereto.

It should be noted that FIG. 14 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 14.

It can be seen from the above embodiment that the terminal equipment transmits the first message in the random access procedure to the network device, the first message including beam failure recovery information of one TRP. Therefore, the first message in the random access procedure may carry beam failure recovery information of one TRP, and implicitly indicate beam failure recovery information of another TRP, so that the network performs beam recovery. A format of an existing MAC CE may be reused in the embodiment of this disclosure at a relatively low cost.

### Embodiment of a Third Aspect

The embodiment of this disclosure provides a beam failure recovery information reception method, which shall be described from a network device.

FIG. 19 is a schematic diagram of the beam failure recovery information reception method of the embodiment of this disclosure. As shown in FIG. 19, the method includes:
1901: the network device transmits candidate beam configuration information to a terminal equipment; and
1902: the network device receives, a first message in a random access procedure transmitted by the terminal equipment, the first message including a first beam failure recovery MAC CE having a fixed size or the first message including a second beam failure recovery MAC CE, the first beam failure recovery MAC CE including beam failure recovery information of two TRPs, and the second beam failure recovery MAC CE including beam failure recovery information of a first TRP in the two TRPs.

In some embodiments, in 1901, the configuration information includes TRP related information, the TRP related information being an index of a failed TRP or an index of a BFD-RS set where beam failure is detected or an index of a coreset pool associated with the BFD-RS set where beam failure is detected, or an index of a TRP where a candidate beam or random access resource is located.

In some embodiments, reference may be made to 502 and 1402 in the embodiments of the first and second aspects for implementation of 1902, and formats of the first beam failure recovery MAC CE and the second beam failure recovery MAC CE shall not be repeated herein any further.

It can be seen from the above embodiment that when beam failures are detected at two TRPs, a BFR MAC CE having a fixed size including the beam failure recovery information of the two TRPs needing to be recovered is transmitted or a BFR MAC CE including the beam failure recovery information of one TRP needing to be recovered is transmitted in the random access procedure. Hence, Msg3/MSGA in the random access procedure is able to transmit beam failure recovery information of one or two TRPs at sufficient low overhead, enabling the network device to obtain the beam failure recovery information of the two TRPs, so that the network performs beam recovery.

### Embodiment of a Fourth Aspect

FIG. 20 is a schematic diagram of a beam failure recovery method of the embodiment of this disclosure. As shown in FIG. 20, the method includes:
2001: a terminal equipment suspends beam failure recovery (BFR) or BFR is suspended when the BFR is triggered.

It should be noted that FIG. 20 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 20.

In some embodiments, the method further includes: the beam failure recovery is triggered when a beam failure is detected, including if a beam failure instance indication is received from a lower layer, starting or restarting a beam failure detection timer beam FailureDetectionTimer, and adding 1 to a terminal equipment variable BFI_COUNTER; in a case where BFI_COUNTER is greater than or equal to a maximum count value beamFailureInstanceMaxCount of the beam failure instances, a beam failure is detected, and beam failure recovery (BFR) of the secondary cell is triggered. In 2001, when the BFR is triggered, the terminal equipment suspends the BFR, or the BFR is suspended.

In some embodiments, the BFR is suspended until it is canceled or completed successfully.

In some embodiments, that the BFR is completed successfully includes: that the BFR is completed successfully if a PDCCH addressed to a C-RNTI indicating uplink grant for a new transmission is received for an HARQ process; wherein the HARQ process is used for transmission of an enhanced BFR MAC CE or truncated enhanced BFR MAC CE, the enhanced BFR MAC CE or truncated enhanced BFR MAC CE containing the BFR information. That is, when the beam failure recovery (BFR) is triggered, the terminal equipment suspends the BFR or the BFR is suspended. If the newly-transmitted uplink grant of the HARQ process indicated by the PDCCH addressed by the C-RNTI is received, the HARQ process is used for transmission of an enhanced BFR MAC CE or a truncated enhanced BFR MAC CE, and the enhanced BFR MAC CE or the truncated enhanced BFR MAC CE includes the BFR information, the BFR is completed successfully, the BFR ends in suspension, or the BFR is not suspended.

In some embodiments, the BFR is cell-specific or TRP-specific.

In some embodiments, the BFR is TRP-specific, and that the TRP-specific BFR is completed successfully includes: that the TRP-specific BFR is completed successfully if a PDCCH addressed to a C-RNTI indicating uplink grant for a new transmission is received for an HARQ process; wherein the HARQ process is used for transmission of an enhanced BFR MAC CE or truncated enhanced BFR MAC CE, the enhanced BFR MAC CE or truncated enhanced BFR MAC CE including the TRP-specific BFR information. That is, when the beam failure recovery (BFR) is triggered, the terminal equipment suspends the BFR or the BFR is suspended. If the newly-transmitted uplink grant of the HARQ process indicated by the PDCCH addressed by the C-RNTI is received, the HARQ process is used for transmission of an enhanced BFR MAC CE or a truncated enhanced BFR MAC CE, and the enhanced BFR MAC CE or the truncated enhanced BFR MAC CE includes the TRP-specific BFR information, the BFR is completed successfully, the BFR ends (stops) in suspension, or the BFR is not suspended.

In some embodiments, the method may further include:
the terminal equipment receives, a newly-transmitted uplink grant of an HARQ process indicated by a PDCCH addressed by a C-RNTI, wherein the HARQ process is used for transmission of an enhanced BFR MAC CE or a truncated enhanced BFR MAC CE, and the enhanced BFR MAC CE or the truncated enhanced BFR MAC CE includes the BFR information or the TRP-specific BFR information.

In some embodiments, when beam failures are detected at two TRPs of a secondary cell, BFR of the two TRPs is suspended.

In some embodiments, when an MAC PDU is transmitted, the PDU includes an enhanced BFR MAC CE or truncated enhanced BFR MAC CE and the BFR MAC CE includes beam failure recovery information of a BFD-RS set of a special cell, all BFRs triggered for the BFD-RS set of the special cell are canceled. At this moment of time, the BFR ends in suspension, or the BFR is not suspended.

In some embodiments, when an MAC PDU is transmitted, the PDU includes an enhanced BFR MAC CE or truncated enhanced BFR MAC CE and the BFR MAC CE includes beam failure recovery information of a BFD-RS set of the serving cell, all BFRs triggered for the BFD-RS set of the special cell are canceled. At this moment of time, the BFR ends in suspension, or the BFR is not suspended.

In some embodiments, when an MAC PDU is transmitted, the PDU includes a BFR MAC CE or truncated enhanced BFR MAC CE including beam failure recovery information of a secondary cell, all BFRs triggered for the BFD-RS set of the special cell are canceled. At this moment of time, the BFR ends in suspension, or the BFR is not suspended.

In some embodiments, when an MAC PDU is transmitted and the PDU includes a BFR MAC CE or truncated BFR MAC CE and the BFR MAC CE includes beam failure recovery information of a BFD-RS set of a secondary cell, all BFRs triggered for the BFD-RS set of the special cell are canceled. At this moment of time, the BFR ends in suspension, or the BFR is not suspended.

In some embodiments, when an MAC PDU is transmitted and the PDU includes a BFR MAC CE or truncated BFR MAC CE and the BFR MAC CE includes beam failure recovery information of a BFD-RS set of a special cell, all BFRs triggered for the BFD-RS set of the special cell are canceled. At this moment of time, the BFR ends in suspension, or the BFR is not suspended.

In some embodiments, when an MAC PDU is transmitted, the PDU includes a BFR MAC CE or truncated BFR MAC CE and the BFR MAC CE includes beam failure recovery information of a BFD-RS set of the serving cell, all BFRs triggered for the BFD-RS set of the special cell are canceled. At this moment of time, the BFR ends in suspension, or the BFR is not suspended.

It should be noted that the embodiments of the first, second and fourth aspects may be implemented separately, or may be implemented in a combined manner, and the embodiments of this disclosure are not limited thereto.

### Embodiment of a Fifth Aspect

The embodiment of this disclosure provides a beam failure recovery information transmission apparatus. The apparatus may be, for example, a terminal equipment, or may also be one or more components or assemblies configured in the terminal equipment, with contents identical to those in the embodiment of the first or the second aspect being not going to be described herein any further.

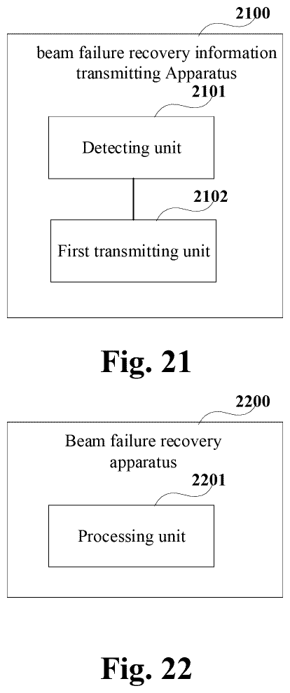

FIG. 21 is a schematic diagram of the beam failure recovery information transmission apparatus of the embodiment of this disclosure. As shown in FIG. 21, a beam failure recovery information transmission apparatus 2100 includes:
a detecting unit 2101 configured to detect beam failures at both transmission/reception points (TRPs) of a special cell; and
a first transmitting unit 2102 configured to transmit a first message in a random access procedure to a network device, the first message including a first beam failure recovery medium access control (MAC) control element (CE) having a fixed size, or the first message including a second beam failure recovery MAC CE, the first beam failure recovery MAC CE including beam failure recovery information of the two TRPs, and the second beam failure recovery MAC CE including beam failure recovery information of a first TRP in the two TRPs.

In some embodiments, reference may be made to 501-502 and 1401-1402 for implementations of the detecting unit 2101 and the first transmitting unit 2102, which shall not be described herein any further.

In some embodiments, the first message includes MSG3 or MSGA.

In some embodiments, reference may be made to the embodiment of the first or the second aspect for implementations of the first beam failure recovery MAC CE and the second beam failure recovery MAC CE, which shall not be described herein any further.

In some embodiments, the first transmitting unit initiates the random access procedure at a random access resource of a second TRP in the two TRPs.

In some embodiments, the first transmitting unit is further configured to transmit a random access preamble at a random access channel occasion (RO) corresponding to a first downlink reference signal, the first downlink reference signal corresponding to the second TRP.

In some embodiments, the apparatus may further include:
a first receiving unit (not shown, optional) configured to receive candidate beam configuration information transmitted by the network device, the configuration information including TRP related information, the TRP related information being the index of the failed TRP or the index of the BFD-RS set where beam failure is detected or index of the coreset pool associated with the BFD-RS set where beam failure is detected, or an index of a TRP where a candidate beam or random access resource is located, or an index of a BFD-RS set corresponding to the TRP or an index of a coreset pool associated with BFD-RS set.

In some embodiments, the apparatus may further include (at least one of the following, not shown, optional):
a second receiving unit configured to receive an RAR, an uplink grant indicated by the RAR or an uplink resource configured by the RAR being insufficient to carry an enhanced beam failure recovery MAC CE including the beam failure recovery information of the two failed TRPs;
a third receiving unit configured to receive first indication information transmitted by the network device;
a first detecting unit configured to detect that a highest serving cell index ServCellIndex of a secondary cell where the TRP with beam failure is located/with which the TRP with beam failure is associated is less than 8; or
a second detecting unit configured to detect that the special cell where the TRP with beam failure is located is to be indicated as being in a truncated BFR MAC CE and UL-SCH resources cannot accommodate a truncated BFR MAC CE with a 4 octets bitmap plus its subheader as a result of logical channel prioritization (LCP).

When at least one of the second receiving unit, the third receiving unit, the first detecting unit and the second detecting unit completes its operation, the first transmitting unit transmits a first message including the first beam failure recovery MAC CE or the second beam failure recovery MAC CE.

In some embodiments, the first indication information is used to indicate that resources accommodating the first message are few, or indicate that the first message carries minimum data, or indicate that the first message includes the first beam failure recovery MAC CE/the second beam failure recovery MAC CE.

In some embodiments, the first indication information is included in the RAR, or in a UL grant of the RAR, or in DCI scheduling the RAR.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the beam failure recovery information transmission apparatus 2100 may further include other components or modules, and reference may be made to related techniques for particulars of these components or modules.

Furthermore, for the sake of simplicity, connection relationships between the components or modules or signal profiles thereof are only illustrated in FIG. 21. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that when beam failures are detected in two TRPs, a BFR MAC CE having a fixed size including the beam failure recovery information of the two TRPs needing to be recovered is transmitted or a BFR MAC CE including the beam failure recovery information of one TRP needing to be recovered is transmitted in the random access procedure. Hence, Msg3/MSGA in the random access procedure is able to transmit beam failure recovery information of one or two TRPs at sufficient low overhead, enabling the network device to obtain the beam failure recovery information of the two TRPs, so that the network performs beam recovery.

### Embodiment of a Sixth Aspect

The embodiment of this disclosure provides a beam failure recovery apparatus. The apparatus may be, for example, a terminal equipment, or may also be one or more components or assemblies configured in the terminal equipment, with contents identical to those in the embodiment of the fourth aspect being not going to be described herein any further.

FIG. 22 is a schematic diagram of the beam failure recovery apparatus of the embodiment of this disclosure. As shown in FIG. 22, a beam failure recovery apparatus 2200 includes:
a processing unit 2201 configured to suspend beam failure recovery (BFR) or the BFR be suspended when the BFR is triggered.

In some embodiments, reference may be made to 2001 in the embodiment of the fourth aspect for implementation of the processing unit 2201, which shall not be described herein any further.

In some embodiments, the processing unit 2201 triggers the beam failure recovery when a beam failure is detected.

In some embodiments, the BFR is suspended until it is canceled or completed successfully.

In some embodiments, that the BFR is completed successfully includes:
that the BFR is completed successfully if a PDCCH addressed to a C-RNTI indicating uplink grant for a new transmission is received for an HARQ process; wherein the HARQ process is used for transmission of an enhanced BFR MAC CE or truncated enhanced BFR MAC CE, the enhanced BFR MAC CE or truncated enhanced BFR MAC CE containing the BFR information.

In some embodiments, the BFR is cell-specific or TRP-specific.

In some embodiments, the BFR is TRP-specific, and that the TRP-specific BFR is completed successfully includes:
that the TRP-specific BFR is completed successfully if a PDCCH addressed to a C-RNTI indicating uplink grant for a new transmission is received for an HARQ process; wherein the HARQ process is used for transmission of an enhanced BFR MAC CE or truncated enhanced BFR MAC CE, the enhanced BFR MAC CE or truncated enhanced BFR MAC CE including the TRP-specific BFR information.

In some embodiments, when beam failures are detected at two TRPs of a secondary cell, the processing unit suspends BFR of the two TRPs, or BFR of the two TRPs is suspended.

In some embodiments, when an MAC PDU is transmitted, the PDU includes an enhanced BFR MAC CE or truncated enhanced BFR MAC CE and the BFR MAC CE includes beam failure recovery information of a BFD-RS set of a special cell, all BFRs triggered for the BFD-RS set of the special cell are canceled by the processing unit.

In some embodiments, when an MAC PDU is transmitted, the PDU includes an enhanced BFR MAC CE or truncated enhanced BFR MAC CE and the BFR MAC CE includes beam failure recovery information of a BFD-RS set of the serving cell, all BFRs triggered for the BFD-RS set of the special cell are canceled by the processing unit.

In some embodiments, when an MAC PDU is transmitted, the PDU includes a BFR MAC CE or truncated enhanced BFR MAC CE including beam failure recovery information of a secondary cell, all BFRs triggered for the BFD-RS set of the special cell are canceled by the processing unit.

In some embodiments, when an MAC PDU is transmitted and the PDU includes a BFR MAC CE or truncated BFR MAC CE and the BFR MAC CE includes beam failure recovery information of a BFD-RS set of a secondary cell, all BFRs triggered for the BFD-RS set of the special cell are canceled by the processing unit.

In some embodiments, when an MAC PDU is transmitted and the PDU includes a BFR MAC CE or truncated BFR MAC CE and the BFR MAC CE includes beam failure recovery information of a BFD-RS set of a special cell, all BFRs triggered for the BFD-RS set of the special cell are canceled by the processing unit.

In some embodiments, when an MAC PDU is transmitted, the PDU includes a BFR MAC CE or truncated BFR MAC CE and the BFR MAC CE includes beam failure recovery information of a BFD-RS set of the serving cell, all BFRs triggered for the BFD-RS set of the special cell are canceled by the processing unit.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the beam failure recovery apparatus 2200 may further include other components or modules, and reference may be made to related techniques for particulars of these components or modules.

Furthermore, for the sake of simplicity, connection relationships between the components or modules or signal profiles thereof are only illustrated in FIG. 22. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It should be noted that the embodiments of the fifth and sixth aspects may be implemented separately, or may be implemented in a combined manner, and the embodiments of this disclosure are not limited thereto.

### Embodiment of a Seventh Aspect

The embodiment of this disclosure provides a beam failure recovery information receiving apparatus. The apparatus may be, for example, a network device, or may also be one or more components or assemblies configured in the network device, with contents identical to those in the embodiment of the third aspect being not going to be described herein any further.

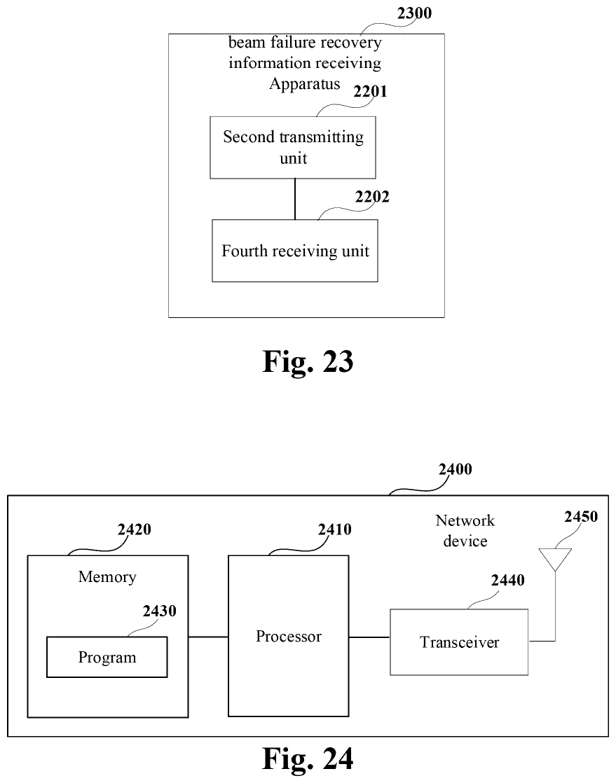

FIG. 23 is a schematic diagram of the beam failure recovery information reception apparatus of the embodiment of this disclosure. As shown in FIG. 23, a beam failure recovery information reception apparatus 2300 includes:
a second transmitting unit 2201 configured to transmit candidate beam configuration information to a terminal equipment; and
a fourth receiving unit 2202 configured to receive a first message in a random access procedure transmitted by the terminal equipment, the first message including a first beam failure recovery MAC CE having a fixed size or the first message including a second beam failure recovery MAC CE, the first beam failure recovery MAC CE including beam failure recovery information of two TRPs, and the second beam failure recovery MAC CE including beam failure recovery information of a first TRP in the two TRPs.

In some embodiments, reference may be made to 1901-1902 in the embodiment of the third aspect for implementations of the second transmitting unit 2201 and the fourth receiving unit 2202, which shall not be described herein any further. And reference may be made to the embodiment of the first or the second aspect for implementations of the first beam failure recovery MAC CE and the second beam failure recovery MAC CE, which shall not be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatus 2300 for receiving beam failure recovery information may further include other components or modules, and reference may be made to related techniques for particulars of these components or modules.

Furthermore, for the sake of simplicity, connection relationships between the components or modules or signal profiles thereof are only illustrated in FIG. 23. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that when beam failures are detected at two TRPs, a BFR MAC CE having a fixed size including the beam failure recovery information of the two TRPs needing to be recovered is transmitted or a BFR MAC CE including the beam failure recovery information of one TRP needing to be recovered is transmitted in the random access procedure. Hence, Msg3/MSGA in the random access procedure is able to transmit beam failure recovery information of one or two TRPs at sufficient low overhead, enabling the network device to obtain the beam failure recovery information of the two TRPs, so that the network performs beam recovery.

### Embodiment of an Eighth Aspect

The embodiment of this disclosure provides a communication system, and reference may be made to FIG. 1, with contents identical to those in the embodiments of the first to the seventh aspects being not going to be described herein any further.

In some embodiments, the communication system may include a terminal equipment 2500.

In some embodiments, the communication system may include a network device 2400.

The embodiment of this disclosure further provides a network device, which may be, for example, a base station. However, this disclosure is not limited thereto, and it may also be another network device.

FIG. 24 is a schematic diagram of a structure of the network device of the embodiment of this disclosure. As shown in FIG. 24, the network device 2400 may include a processor 2410 (such as a central processing unit (CPU)) and a memory 2420, the memory 2420 being coupled to the processor 2410. The memory 2420 may store various data, and furthermore, it may store a program 2430 for information processing, and execute the program 2430 under control of the processor 2410.

For example, the processor 2410 may be configured to execute a program to carry out the beam failure recovery information reception method as described in the embodiment of the third aspect.

Furthermore, as shown in FIG. 24, the network device 2400 may include a transceiver 2440, and an antenna 2450, etc. Functions of the above components are similar to those in the related art, and shall not be described herein any further. It should be noted that the network device 2400 does not necessarily include all the parts shown in FIG. 24, and furthermore, the network device 2400 may include parts not shown in FIG. 24, and the related art may be referred to.

The embodiment of this disclosure further provides a terminal equipment; however, this disclosure is not limited thereto, and it may also be another equipment.

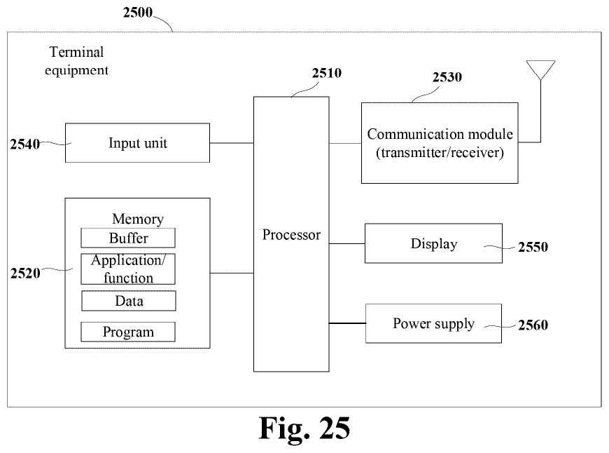

FIG. 25 is a schematic diagram of the terminal equipment of the embodiment of this disclosure. As shown in FIG. 25, the terminal equipment 2500 may include a processor 2510 and a memory 2520, the memory 2520 storing data and a program and being coupled to the processor 2510. It should be noted that this figure is illustrative only, and other types of structures may also be used, so as to supplement or replace this structure and achieve a telecommunications function or other functions.

For example, the processor 2510 may be configured to execute a program to carry out the beam failure recovery information transmitting method or the beam failure recovery method as described in the embodiment of the first or the second or the fourth aspect.

As shown in FIG. 25, the terminal equipment 2500 may further include a communication module 2530, an input unit 2540, a display 2550, and a power supply 2560, wherein functions of the above components are similar to those in the related art, which shall not be described herein any further. It should be noted that the terminal equipment 2500 does not necessarily include all the parts shown in FIG. 25, and the above components are not necessary. Furthermore, the terminal equipment 2500 may include parts not shown in FIG. 25, and the related art may be referred to.

An embodiment of this disclosure provides a computer readable program, which, when executed in a terminal equipment, causes the terminal equipment to carry out the beam failure recovery information transmission method as described in the embodiments of the first and second aspects.

An embodiment of this disclosure provides a computer storage medium, including a computer readable program, which causes a terminal equipment to carry out the beam failure recovery information transmission method as described in the embodiments of the first and second aspects.

An embodiment of this disclosure provides a computer readable program, which, when executed in a terminal equipment, causes the terminal equipment to carry out the beam failure recovery method as described in the embodiment of the fourth aspect.

An embodiment of this disclosure provides a computer storage medium, including a computer readable program code, which causes a terminal equipment to carry out the beam failure recovery method as described in the embodiment of the fourth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A beam failure recovery information transmission method, applicable to a terminal equipment, characterized in that the method includes:
detecting beam failures at two transmission/reception points (TRPs) of a special cell by the terminal equipment; and
transmitting a first message in a random access procedure by the terminal equipment to a network device, the first message including a first beam failure recovery MAC CE having a fixed size or the first message including a second beam failure recovery MAC CE, the first beam failure recovery MAC CE including beam failure recovery information of two TRPs, and the second beam failure recovery MAC CE including beam failure recovery information of a first TRP in the two TRPs.
2. The method according to supplement 1, wherein the first message includes MSG3 or MSGA.
3. The method according to supplement 1 or 2, wherein the first MAC subheader to which the first beam failure recovery MAC CE corresponds at least includes a first LCID, the first LCID being used to indicate the first beam failure recovery MAC CE having a fixed size.
4. The method according to supplement 3, wherein a value of the first LCID is a reserved value of LCID for UL-SCH.
5. The method according to supplement 4, wherein the value of the first LCID is one of 35,36,43,44.
6. The method according to supplement 1 or 2, wherein the first MAC subheader to which the first beam failure recovery MAC CE corresponds at least includes a first LCID and a first eLCID, the first LCID being used to indicate an extended LCID field, and the first eLCID being used to indicate the first beam failure recovery MAC CE having a fixed size.
7. The method according to supplement 6, wherein a value of the first eLCID is a reserved value of eLCID for UL-SCH.
8. The method according to supplement 7, wherein the value of the first eLCID is one of 0-249.
9. The method according to any one of supplements 3-6, wherein the first MAC subheader does not include bit information indicating a length.
10. The method according to any one of supplements 1-9, wherein the first beam failure recovery MAC CE at least includes an AC field and a candidate reference signal ID field or a reserved bit field
11. The method according to supplement 10, wherein the first beam failure recovery MAC CE further includes a TRP information field.
12. The method according to supplement 10 or 11, wherein the first beam failure recovery MAC CE further includes a Ci/SP field.
13. The method according to any one of supplements 10-12, wherein the AC field is used to indicate whether a candidate beam of a failed TRP of the special cell is available, the candidate reference signal ID field is used to indicate a candidate beam of the failed TRP, and the TRP information field is used to indicate whether a beam failure is detected at the failed TRP in the two TRPs or indicate whether a beam failure is detected at a TRP in the two TRPs.
14. The method according to supplement 13, wherein,
when the TRP information field is used to indicate a failed TRP in the two TRPs, a value of the TRP information field is index of a TRP where beam failure is detected or an index of a beam failure detection reference signal (BFD-RS) set or an index of a control resource set (coreset) pool associated with the index of a TRP where beam failure is detected; or,
when the TRP information field is used to indicate whether beam failure is detected at a TRP in the two TRPs, a value of the TRP information field being a first value indicates that no beam failure is detected at the TRP, and a value of the TRP information field being a second value indicates that beam failure is detected at the TRP.
15. The method according to supplement 13, wherein the candidate reference signal ID field is an index of a synchronization signal block (SSB) or a channel state information reference signal (CSI-RS).
16. The method according to supplement 1 or 2, wherein the terminal equipment initiates the random access procedure on a random access resource of the second TRP in the two TRPs.
17. The method according to supplement 16, wherein the method further includes:
transmitting a random access preamble by the terminal equipment at a random access channel occasion (RO) to which a first downlink reference signal corresponds, the first downlink reference signal corresponding to the second TRP.
18. The method according to supplement 16, wherein the method further includes:
receiving, by the terminal equipment, candidate beam configuration information transmitted by the network device, the configuration information including TRP-related information, the TRP-related information being the index of the failed TRP or the index of the BFD-RS set where beam failure is detected or index of the coreset pool associated with the BFD-RS set where beam failure is detected, or an index of a TRP where a candidate beam or random access resource is located, or an index of a BFD-RS set corresponding to the TRP or an index of a coreset pool associated with BFD-RS set.
19. The method according to any one of supplements 16-18, wherein the second beam failure recovery MAC CE at least includes an AC field and a candidate reference signal ID field or a reserved bit field.
20. The method according to supplement 19, wherein the second beam failure recovery MAC CE further includes a TRP information field.
21. The method according to supplement 20, wherein the TRP information field is used to indicate the failed first TRP or a BFD-RS set or coreset pool with a special cell where a beam failure is detected, the BFD-RS set or coreset pool corresponding to the first TRP, the AC field is used to indicate whether a candidate reference signal ID field presents or whether a candidate beam of a failed TRP of the special cell is available, and the candidate reference signal ID field is used to indicate a candidate beam of the failed TRP.
22. The method according to supplement 21, wherein the candidate reference signal ID field is an index of an SSB or a CSI-RS.
23. The method according to supplement 19 or 20, wherein the second beam failure recovery MAC CE further includes a Ci/SP field.
24. The method according to any one of supplements 16-23, wherein the second MAC subheader to which the second beam failure recovery MAC CE corresponds at least includes a second LCID, the second LCID being used to indicate an MAC CE of single bitmap beam failure recovery, or an MAC CE of single bitmap truncated beam failure recovery, or an enhanced beam failure recovery MAC CE.
25. The method according to any one of supplements 16-23, wherein the second MAC subheader to which the second beam failure recovery MAC CE corresponds at least includes a second LCID and a second eLCID, the second LCID being used to indicate an extended LCID field, and the second eLCID being used to indicate an MAC CE of beam failure recovery.
26. The method according to supplement 24 or 25, wherein the second MAC subheader includes bit information indicating a length.
27. The method according to any one of supplements 1-26, wherein the method further includes at least one of the following:
receiving, by the terminal equipment, a random access response (RAR), an uplink grant indicated by the RAR or an uplink resource configured by the RAR being insufficient to carry an enhanced beam failure recovery MAC CE including the beam failure recovery information of the two failed TRPs;
receiving, by the terminal equipment, first indication information transmitted by the network device;
detecting by the terminal equipment that a highest serving cell index ServCellIndex of a secondary cell where the TRP with beam failure is located/with which the TRP with beam failure is associated is less than 8; and
detecting by the terminal equipment that the special cell where the TRP with beam failure is located is to be indicated in a truncated BFR MAC CE and UL-SCH resources cannot accommodate a truncated BFR MAC CE with a 4 octets bitmap plus its subheader as a result of logical channel prioritization (LCP).
28. The method according to supplement 27, wherein the first indication information is used to indicate that there are few resources to accommodate the first message, or to indicate that the first message carries minimum data, or to indicate that the first message includes a first/second beam failure recovery MAC CE(s).
29. The method according to supplement 27, wherein the first indication information is included in a random access response (RAR), or in a UL grant of an RAR, or in DCI scheduling an RAR.
30. A beam failure recovery information reception method, applicable to a network device side, characterized in that the method includes:
transmitting candidate beam configuration information by the network device to a terminal equipment; and
receiving, by the network device, a first message in a random access procedure transmitted by the terminal equipment, the first message including a first beam failure recovery MAC CE having a fixed size or the first message including a second beam failure recovery MAC CE, the first beam failure recovery MAC CE including beam failure recovery information of two TRPs, and the second beam failure recovery MAC CE including beam failure recovery information of a first TRP in the two TRPs.
31. A beam failure recovery method, characterized in that the method includes:
suspending beam failure recovery (BFR) by a terminal equipment or the BFR being suspended when the BFR is triggered.
32. The method according to supplement 31, wherein the beam failure recovery (BFR) is triggered when a beam failure is detected.
33. The method according to supplement 31, wherein the BFR is suspended until it is canceled or completed successfully.
34. The method according to supplement 33, wherein that the BFR is completed successfully includes:
that the BFR is completed successfully if a PDCCH addressed to a C-RNTI indicating uplink grant for a new transmission is received for an HARQ process;
wherein,
the HARQ process is used for transmission of an enhanced BFR MAC CE or truncated enhanced BFR MAC CE, the enhanced BFR MAC CE or truncated enhanced BFR MAC CE containing the BFR information.
35. The method according to either one of supplements 31 and 32, wherein the BFR is cell-specific or TRP-specific.
36. The method according to supplement 35, wherein the BFR is TRP-specific, and that the TRP-specific BFR is completed successfully includes:
that the TRP-specific BFR is completed successfully if a PDCCH addressed to a C-RNTI indicating uplink grant for a new transmission is received for an HARQ process;
wherein,
the HARQ process is used for transmission of an enhanced BFR MAC CE or truncated enhanced BFR MAC CE, the enhanced BFR MAC CE or truncated enhanced BFR MAC CE including the TRP-specific BFR information.
37. The method according to supplement 32, wherein,
when beam failures are detected in two TRPs of a secondary cell, BFR of the two TRPs is suspended.
38. The method according to supplement 35, wherein,
when an MAC PDU is transmitted, the PDU includes an enhanced BFR MAC CE or truncated enhanced BFR MAC CE and the BFR MAC CE includes beam failure recovery information of a BFD-RS set of a special cell, all BFRs triggered for the BFD-RS set of the special cell are canceled.
39. The method according to supplement 35, wherein,
when an MAC PDU is transmitted, the PDU includes an enhanced BFR MAC CE or truncated enhanced BFR MAC CE and the BFR MAC CE includes beam failure recovery information of a BFD-RS set of the serving cell, all BFRs triggered for the BFD-RS set of the serving cell are canceled.
40. The method according to supplement 35, wherein,
when an MAC PDU is transmitted, the PDU includes a BFR MAC CE or truncated enhanced BFR MAC CE including beam failure recovery information of a secondary cell, all BFRs triggered for both BFD-RS sets of the secondary cell are canceled.
41. The method according to supplement 35, wherein,
when an MAC PDU is transmitted and the PDU includes a BFR MAC CE or truncated BFR MAC CE and the BFR MAC CE includes beam failure recovery information of a BFD-RS set of a secondary cell, all BFR triggered for the BFD-RS set of the secondary cell are canceled.
42. The method according to supplement 35, wherein,
when an MAC PDU is transmitted and the PDU includes a BFR MAC CE or truncated BFR MAC CE and the BFR MAC CE includes beam failure recovery information of a BFD-RS set of a special cell, all BFRs triggered for the BFD-RS set of the special cell are canceled.
43. The method according to supplement 35, wherein,
when an MAC PDU is transmitted, the PDU includes a BFR MAC CE or truncated BFR MAC CE and the BFR MAC CE includes beam failure recovery information of a BFD-RS set of the serving cell, all BFRs triggered for the BFD-RS set of the serving cell are canceled.
44. A network device, including a memory and a processor, the memory storing a computer program, wherein the processor is configured to execute the computer program to carry out the beam failure recovery information reception method described in supplement 30.
45. A terminal equipment, including a memory and a processor, the memory storing a computer program, wherein the processor is configured to execute the computer program to carry out the method described in any one of supplements 1-29 and 31-43.
46. A beam failure recovery apparatus, applicable to a terminal equipment, characterized in that the apparatus includes:
a processing unit configured to suspend beam failure recovery (BFR) or the BFR be suspended when the BFR is triggered.
47. The method according to supplement 46, wherein the processing unit triggers the beam failure recovery (BFR) when a beam failure is detected.
48. The method according to supplement 46, wherein the BFR is suspended until it is canceled or completed successfully.
49. The method according to supplement 46, wherein that the BFR is completed successfully includes:
that the BFR is completed successfully if a PDCCH addressed to a C-RNTI indicating uplink grant for a new transmission is received for an HARQ process;
wherein the HARQ process is used for transmission of an enhanced BFR MAC CE or truncated enhanced BFR MAC CE, the enhanced BFR MAC CE or truncated enhanced BFR MAC CE containing the BFR information.
50. The method according to any one of supplements 46-48, wherein the BFR is cell-specific or TRP-specific.
51. The method according to supplement 48, wherein the BFR is TRP-specific, and that the TRP-specific BFR is completed successfully includes:
that the TRP-specific BFR is completed successfully if a PDCCH addressed to a C-RNTI indicating uplink grant for a new transmission is received for an HARQ process;
wherein the HARQ process is used for transmission of an enhanced BFR MAC CE or truncated enhanced BFR MAC CE, the enhanced BFR MAC CE or truncated enhanced BFR MAC CE including the TRP-specific BFR information.
52. The method according to supplement 47, wherein,
when beam failures are detected in two TRPs of a secondary cell, the processing unit suspends BFR of the two TRPs, or BFR of the two TRPs is suspended.
53. The method according to supplement 48, wherein,
when an MAC PDU is transmitted, the PDU includes an enhanced BFR MAC CE or truncated enhanced BFR MAC CE and the BFR MAC CE includes beam failure recovery information of a BFD-RS set of a special cell, all triggered BFR of the BFD-RS set of the special cell is canceled by the processing unit.
54. The method according to supplement 48, wherein,
when an MAC PDU is transmitted, the PDU includes an enhanced BFR MAC CE or truncated enhanced BFR MAC CE and the BFR MAC CE includes beam failure recovery information of a BFD-RS set of the serving cell, all triggered BFR of the BFD-RS set of the serving cell is canceled by the processing unit.
55. The method according to supplement 48, wherein,
when an MAC PDU is transmitted, the PDU includes a BFR MAC CE or truncated enhanced BFR MAC CE including beam failure recovery information of a secondary cell, all triggered BFR of the BFD-RS set of the secondary cell is canceled by the processing unit.
56. The method according to supplement 48, wherein,
when an MAC PDU is transmitted and the PDU includes a BFR MAC CE or truncated BFR MAC CE and the BFR MAC CE includes beam failure recovery information of a BFD-RS set of a secondary cell, all triggered BFR of the BFD-RS set of the secondary cell is canceled by the processing unit.
57. The method according to supplement 48, wherein,
when an MAC PDU is transmitted and the PDU includes a BFR MAC CE or truncated BFR MAC CE and the BFR MAC CE includes beam failure recovery information of a BFD-RS set of a special cell, all triggered BFR of the BFD-RS set of the special cell is canceled by the processing unit.
58. The method according to supplement 48, wherein,
when an MAC PDU is transmitted, the PDU includes a BFR MAC CE or truncated BFR MAC CE and the BFR MAC CE includes beam failure recovery information of a BFD-RS set of the serving cell, all triggered BFR of the BFD-RS set of the serving cell is canceled by the processing unit.
59. A communication system, including:
the terminal equipment as described in supplement 45, and/or the network device as described in supplement 44.

1. A beam failure recovery information transmitting apparatus, applicable to a terminal equipment, the apparatus comprising:
processor circuitry configured to detect beam failures at two BFD-RS (beam failure detection reference signal) sets of a first cell; and
a transmitter configured to transmit a first message in a random access procedure to a network device, the first message including a truncated beam failure recovery medium access control (MAC) control element (CE), the truncated beam failure recovery MAC CE including beam failure recovery information of a failed BFD-RS set.

2. The apparatus according to claim 1, wherein the first message comprises MSG3 or MSGA.

3. The apparatus according to claim 1, wherein the apparatus further comprising:
a receiver configured to receive candidate beam configuration information from the network device, the configuration information including indexes of the two BFD-RS sets.

4. The apparatus according to claim 1, wherein the truncated beam failure recovery MAC CE comprises at least an AC field, a SP field, and a candidate reference signal ID field or reserved bits.

5. The apparatus according to claim 4, wherein the truncated beam failure recovery MAC CE further comprises a BFD-RS set information field.

6. The apparatus according to claim 5, wherein the BFD-RS set information field is used to indicate an index of the failed BFD-RS set, and the AC field is used to indicate whether the candidate reference signal ID field presents or whether a candidate beam of the failed BFD-RS set of the first cell is available, the candidate reference signal ID field is used to indicate an index of a SSB or a CSI-RS of the failed BFD-RS set.

7. The apparatus according to claim 6, if the AC field set to 1, the candidate reference signal ID field is present, if the AC field set to 0, reserved bits are present instead of the candidate reference signal ID field.

8. The apparatus according to claim 6, if the SP field set to 1, it indicates that beam failure is detected for at least one BFD-RS set of the first cell.

9. The apparatus according to claim 5, a size of the BFD-RS set information field is 1 bit.

10. The apparatus according to claim 1, wherein a MAC subheader to which the truncated beam failure recovery MAC CE corresponds at least comprises an LCID (logical channel identifier), the LCID being used to indicate a single bitmap truncated beam failure recovery MAC CE.

11. The apparatus according to claim 10, a value of the LCID is any of values 35-44.

12. The apparatus according to claim 1, wherein the processor circuitry is further configured to:
detect that a highest serving cell index ServCellIndex of a secondary cell to which the BFD-RS set with beam failure is associated is less than 8; and
detect that the first cell to which the BFD-RS set with beam failure is associated is to be indicated as being in the truncated BFR (beam failure recovery) MAC CE and UL-SCH resources cannot accommodate the truncated BFR MAC CE of a 4 octets bitmap plus its subheader as a result of logical channel priority (LCP).

13. A beam failure recovery information receiving apparatus, applicable to a network device, the apparatus comprising:
a transmitter configured to transmit candidate beam configuration information to a terminal equipment; and
a receiver configured to receive a first message in a random access procedure transmitted by the terminal equipment, the first message including a truncated beam failure recovery MAC CE, the truncated beam failure recovery medium access control (MAC) control element (CE) including beam failure recovery information of a failed BFD-RS (beam failure detection reference signal) set.

14. The apparatus according to claim 13, wherein the candidate beam configuration information comprising indexes of two BFD-RS sets.

15. The apparatus according to claim 13, wherein the truncated beam failure recovery MAC CE comprises at least an AC field, an SP field and a candidate reference signal ID field or reserved bits.

16. The apparatus according to claim 15, wherein the truncated beam failure recovery MAC CE further comprises a BFD-RS set information field.

17. The apparatus according to claim 16, wherein the BFD-RS set information field is used to indicate an index of the failed BFD-RS set, and the AC field is used to indicate whether the candidate reference signal ID field presents or whether a candidate beam of the failed BFD-RS set of the first cell is available, the candidate reference signal ID field is used to indicate an index of an SSB or a CSI-RS of the failed BFD-RS set.

18. A communication system, comprising a terminal equipment
configured to:
detect beam failures at two BFD-RS (beam failure detection reference signal) sets of a first cell, and
transmit a first message in a random access procedure, the first message including a truncated beam failure recovery medium access control (MAC) control element (CE), the truncated beam failure recovery MAC CE including beam failure recovery information of a failed BFD-RS set; and
a network device configured to receive the first message.
